(19) United States
(12) Patent Application Publication
(10) Pub. No.: US 2020/0318421 A1
(43) Pub. Date: Oct. 8, 2020

(54) DOOR RAIL

(71) Applicant: ASSA ABLOY Accessories and Door Controls Group, Inc., New Haven, CT (US)

(72) Inventors: Kyle R. Murray, Somerset, PA (US); Catelyn Herman, Berlin, PA (US)

(21) Appl. No.: 16/829,168

(22) Filed: Mar. 25, 2020

Related U.S. Application Data
(60) Provisional application No. 62/824,415, filed on Mar. 27, 2019.

(51) Int. Cl. E06B 3/58; E06B 3/02

(52) U.S. Cl. CPC E06B 3/5864; E06B 3/02

(57) ABSTRACT

In one embodiment, a plastic door rail wedge for clamping a door panel to a door rail includes an elongate monolithic body. An inward face of the elongate monolithic body defines a clamping surface that configured to directly engages a side surface of the door panel. An upward end face of the elongate monolithic body defines a supporting surface that is configured to directly engage an end surface of the door panel. An outward face of the elongate monolithic body defines a camming surface that is angled with respect to the clamping surface. The door rail includes a frame with an opening and a bracket disposed within the opening of the frame. The bracket is configured to cam the first and second monolithic plastic door rail wedges toward each other to cause the monolithic plastic door rail wedges to clamp directly against the door panel.

### RELATED APPLICATIONS

This application is a Non-Provisional (35 USC 119(e)) of U.S. Application Ser. No. 62/824,415, filed Mar. 27, 2019, entitled “DOOR RAIL”. The entire contents of which is herein incorporated by reference in its entirety.

### FIELD

The disclosed embodiments are related to door rails for holding panes of glass in a glass door.

### BACKGROUND

Door rails are used to support a pane of glass found in a glass door. In many glass doors, the pane of glass is held in place through compressive forces applied by door rails that are located along the edges of the pane of glass. A door rail wedge is the portion of the door rail that clamps onto the pane of glass and provides the compressive forces. Such wedges are typically made of a metal wedge body coated with a protective material. The protective material is often compliant, allowing sufficient holding power while also preventing any glass breakage that might result if the metal of the wedge body were to directly contact the glass.

### SUMMARY

In one embodiment, a plastic door rail wedge for clamping a door panel to a door rail is provided. The plastic door rail wedge includes an elongate monolithic body. An inward face of the elongate monolithic body defines a clamping surface configured to directly engage a side surface of the door panel. An end face of the elongate monolithic body defines a supporting surface that is configured to engage an end surface of the door panel. The supporting surface is adjacent to and extends perpendicular from the clamping surface. An outward face of the elongate monolithic body defines a camming surface that is angled with respect to the clamping surface.

In another embodiment, a door rail for a door panel is provided. The door rail includes a frame with an opening and a bracket disposed within the opening of the frame. The bracket includes an interior region. A first monolithic plastic door rail wedge is disposed at least partially within the interior region of the bracket. A second monolithic plastic door rail wedge is disposed at least partially within the interior region of the bracket and opposite the first monolithic plastic door rail wedge. The bracket is configured to cam the first and second monolithic plastic door rail wedges toward each other to cause the monolithic plastic door rail wedges to clamp directly against the door panel.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective view of a glass door that includes a pane of glass and one embodiment of door rails;

FIG. 2 is a cross sectional front view of a door rail taken along line 2-2 of FIG. 1, showing one embodiment of door rail wedges; and

FIG. 3 is an exploded perspective view of a portion of a door rail, showing one embodiment of door rail wedges.

### DETAILED DESCRIPTION

As discussed above, current door rail wedges are made of two parts: a wedge body and a protective material that overlies the wedge body. The wedge body is made of a rigid material so that it may support the weight of the pane of glass. Often, the wedge body is made of a hard metal, such as aluminum or steel. It may be undesirable for any metal to directly contact the pane of glass, as this may increase the likelihood of glass breakage. As such, a protective material is disposed on the metal wedge body between the wedge body and the pane of glass. The protective material is often made of a compliant material, such as cork or rubber. In addition to preventing direct contact between the metal wedge body and the pane of glass, the introduction of the protective material may increase the holding power of the door rail wedge. The compliance of the protective material, compared to the relative rigidity of the wedge body, may allow the protective material to conform to the glass more easily than the door rail wedge may otherwise be able to.

However, the inventors have found that the current two-part door rail wedge may be improved. For example, the protective material may separate from the wedge body under load, decreasing the usable lifetime of the door rail wedge. Because the protective material may be in direct contact with the pane of glass, the weight of the pane of glass may exert a shear stress on the protective material. The shear stress between the pane of glass and the protective material may be propagated to the interface between the protective material and the wedge body. These shear stresses could potentially cause the protective material to peel away from the wedge body. This separation between the protective material and the wedge body may compromise the integrity of the door rail wedge and may end its usable lifetime. That is, once the protective material starts separating from the wedge body, the door rail wedge may need to be replaced.

Additionally, the manufacture of a two-part door rail wedge may demand significant time and resources. As discussed above, the wedge body and the protective material may be made of different materials. As such, each material may need to be sourced separately. This process could require identifying multiple suppliers and coordinating separate transportation logistics. Once received, both materials may need to be stored, potentially requiring that the manufacturer keep large inventories.

Furthermore, with a two-part design, each part is typically fabricated separately. The different materials may require separate machines and separate processes for fabrication, potentially increasing the required equipment, space, time, and personnel to fabricate a door rail wedge.

Further, the two parts of the door rail wedge may need to be assembled together. Assembly of the two parts may require additional time, personnel, equipment, and resources. Depending on the joining method, even more materials may be required. For example, if the protective material and the wedge body are joined using an adhesive, that adhesive may need to be identified, sourced, stored, and integrated into the assembly process.

Overall, the additional sourcing, storing, fabricating, and assembling processes that may be required when manufacturing a door rail wedge with two parts may result in increased manufacturing complexity, ultimately yielding potentially longer manufacturing times and higher manufacturing costs.

In view of the limitations of current door rail wedges, the inventors have recognized and appreciated the benefits associated with a door rail wedge made of a single monolithic part. A door rail wedge made of a single part may retain all of the functional benefits of a door rail wedge made of two parts, and yet may have an increased lifetime and may be simpler and less expensive to manufacture.

A door rail wedge formed of a single monolithic part may avoid the limited lifetime concerns of a door rail wedge made of two parts. In a typical two-part door rail wedge, delamination may occur at the interface between the two parts, as discussed above. With a door rail wedge composed of a single monolithic part, no such interface exists. As such, a door rail wedge made of a single part may exhibit longer lifetimes compared to a two-part door rail wedge, as a door rail wedge made of a single part may not suffer from delamination failures.

Additionally, a door rail wedge made of a single part may require only a single material. Compared to a door rail wedge made of two parts, a door rail wedge made of a single part may enable a single supplier of raw material, smaller inventories, a single fabrication process, fewer personnel, and no assembly. Consequently, a door rail wedge made of a single part may be simpler and less expensive to manufacture compared to a door rail wedge made of two parts.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

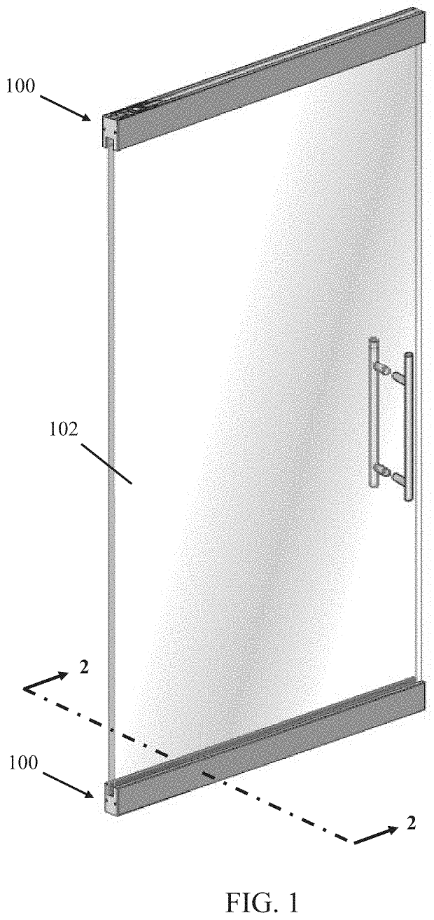

FIG. 1 depicts a glass door with upper and lower rails 100. The glass door also includes a pane of glass 102 held by the door rails 100. The one or more door rails may support the pane of glass along one or more edges of the pane of glass. It should be understood that various arrangements and orientations of the pane of glass and the one or more door rails have been contemplated, and the disclosure is not limited in this regard. For example, the one or more door rails may extend either partially or fully along one or more edges of the pane of glass. A door rail may support the pane of glass along a bottom edge of the pane of glass, along a top edge of a pane of glass, or along a side edge of a pane of glass. A door rail may support the pane of glass along a single edge, or it may support the pane of glass along multiple edges. For example, a door rail may support the pane of glass along a corner of the pane of glass.

Further, it should be understood that, although this disclosure generally refers to a glass door and a pane of glass, the door rails described herein may interface with a door panel of any suitable material. For example, the door rails may interface with a pane or sheet of stone, wood, or composite material, or any other appropriate material.

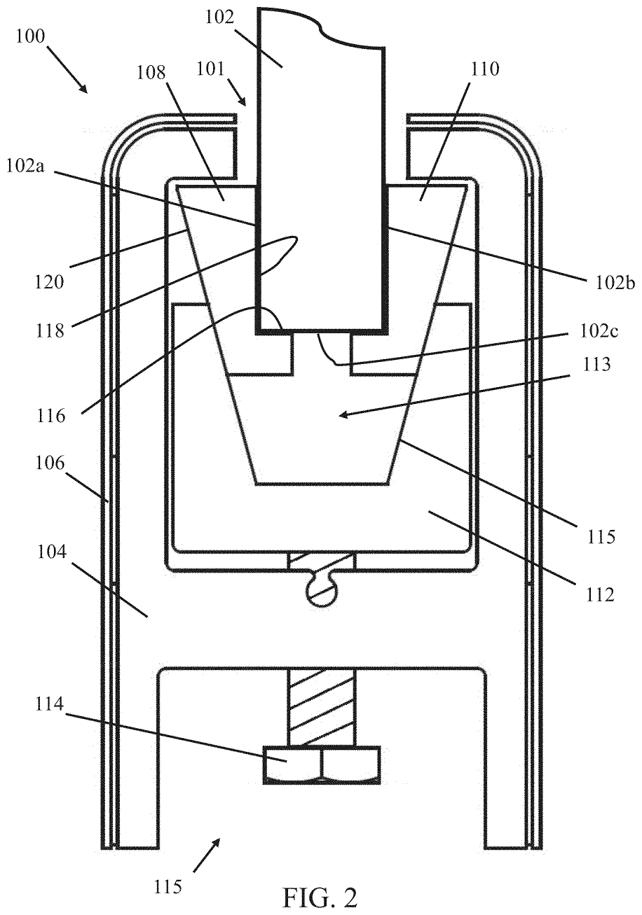

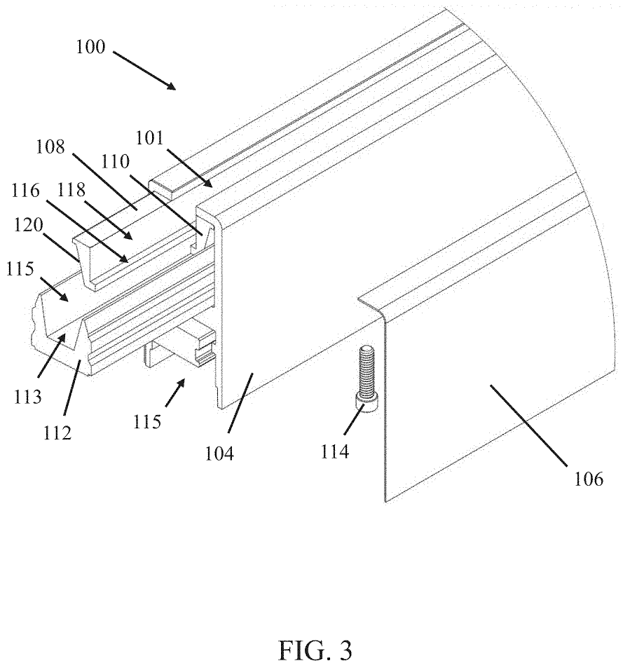

FIGS. 2 and 3 depict various views of a door rail 100, where FIG. 2 shows a cross sectional front view of the door rail, taken along line 2-2 of FIG. 1, and FIG. 3 depicts an exploded perspective view of the door rail. As shown in these figures, the door rail may include a frame 104 and cladding 106. The cladding may be permanently affixed to the frame or may be removable. In some embodiments, the cladding may not be included. The cladding may be made of a different material than the frame, or of the same material. For example, the frame may be made of aluminum, and the cladding may be made of stainless steel. Of course, other combinations of materials of the frame and the cladding are possible, and the disclosure is not limited in this regard.

A top portion of the door rail 100 may comprise a first opening 101. The first opening may alternatively be referred to as a slot, a groove, or a channel. A door panel, such as a pane of glass 102, may be at least partially disposed within the first opening. A bracket 112 may also be disposed within the first opening. The bracket may be of a shape that is substantially U-shaped, and may comprise an interior region 113. The bracket may comprise angled interior faces 115.

A first door rail wedge 108 and a second door rail wedge 110 may be at least partially disposed within the interior region 113 of the bracket 112. The first door rail wedge and the second door rail wedge may be disposed adjacent to the pane of glass 102. The first door rail wedge and the second door rail wedge each may be of a shape that is substantially L-shaped, and each may include a generally horizontal interior face 116 (also referred to as an end face) that defines a supporting surface as well as a generally vertical interior face 118 (also referred to as an inward face) that defines a clamping surface. The generally vertical interior faces may engage with the respective opposite side surfaces 102a and 102b of the pane of glass and clamp thereagainst. The generally horizontal interior faces may engage with an end surface 102c of the pane of glass. The first door rail wedge and the second door rail wedge may be disposed adjacent to the bracket. Each of the first door rail wedge and the second door rail wedge may also comprise an angled exterior face 120 (also referred to as an outward face) that defines a camming surface. The angled exterior faces of the door rail wedges may engage with the angled interior faces 115 of the bracket. The top portions of the door rail wedges may be disposed adjacent to the frame 104.

A bottom portion of the door rail 100 may comprise a second opening 115. The second opening may alternatively be referred to as a slot, a groove, or a channel. Disposed within the second opening may be one or more fasteners 114 operatively coupled to the bracket 112 through one or more holes in the frame. The one or more fasteners may be screws, bolts, or any other type of fastener, as the disclosure is not so limited.

As stated previously, a door rail wedge may be made of a single material. This material may be a non-metallic material, such as a thermoset, a thermoplastic, or a wood product. However, it should be understood that many materials may be appropriate, and the disclosure is not limited in this regard. The door rail wedge may be fabricated in an extrusion process or a molding process. Of course, there are many other methods that may be used to manufacture a door rail wedge, and the disclosure is not limited in this regard.

Additionally, one or more surfaces of a door rail wedge may be mechanically textured or otherwise treated. This surface treatment may alter the friction between the door rail wedge and a pane of glass or between the door rail wedge and one or more other components of the door rail.

The fasteners 114 may be tightened to exert a force on the bracket 112, which may cause the bracket to move in the same direction as the direction of travel of the fasteners. Generally, it may be understood that the direction of travel of the fasteners and the bracket may be towards an edge of the pane of glass 102. For the sake of clarity, this direction may be described as up, upwards, or vertical. However, it should be understood that various arrangements and orientations of door rails and door rail wedges have been contemplated, and the disclosure is not limited in this regard.

It should also be appreciated that other methods of exerting a force on the bracket 112 have been contemplated. As described in this disclosure, a force may be exerted by tightening one or more fasteners 114. However, other suitable mechanisms of exerting a force are possible, and the disclosure is not limited in this regard. For example, a force may be exerted on the bracket with one or more springs that may be disposed within the first opening.

As the bracket 112 travels upwards, it may exert a force on the first door rail wedge 108 and the second door rail wedge 110. Due to the sloped interface between the angled interior faces 115 of the bracket and the angled exterior faces 120 of the door rail wedges, and due to the position of the frame 104 which may prevent upwards motion of the door rail wedges, the upwards travel of the bracket may cause the first door rail wedge and the second door rail wedge to travel towards one another in directions that are substantially perpendicular to the direction of travel of the bracket. That is, the sloped surfaces may cause the upward linear motion of the bracket to translate into linear motion of the door rail wedges in perpendicular direction. This camming action causes the wedges to clamp against the pane of glass 102.

For the sake of clarity, the direction of travel of the first door rail wedge 108 and the second door rail wedge 110 may be described as horizontal. For example, referring to FIG. 2, the upward travel of the bracket 112 may cause the first door rail wedge 108 to travel horizontally to the right and may cause the second door rail wedge 110 to travel horizontally to the left. However, it should be understood that various shapes and orientations of door rail wedges and brackets have been contemplated, and the disclosure is not limited in this fashion.

Regardless of the specific shapes and orientations of the first door rail wedge 108, the second door rail wedge 110, and the bracket 112, the motion of the bracket may cause the door rail wedges to travel towards one another in a substantially horizontal direction. As the first door rail wedges travel towards one another, they may exert a compressive force on the pane of glass 102. The horizontal interior faces 116 of the door rail wedges may prevent the pane of glass 102 from moving downwards, while vertical interior faces 118 of the door rail wedges may exert compressive forces on the pane of glass. Thus, the first door rail wedge and the second door rail wedge may clamp the pane of glass in place.

A door rail may be any appropriate height. For example, the height of the door rail may be 2.75 inches, 4 inches, 6 inches, 10 inches, or any other appropriate height. The top portion of the door rail may be square, tapered, or any other appropriate shape. The door rail may interface with a pane of glass of any appropriate thickness. For example, the pane of glass may be ¼ inch, 5/16 inch, ⅜ inch, 7/16 inch, ½ inch, 9/16 inch, ⅝ inch, 11/16 inch, or ¾ inch thick.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A pair of plastic door rail wedges for clamping a door panel to a door rail, each wedge comprising:
an elongate monolithic body;
an inward face of the elongate monolithic body defining a clamping surface, the clamping surface configured to directly engage a side surface of the door panel;
an end face of the elongate monolithic body defining a supporting surface, the supporting surface configured to engage an end surface of the door panel, the supporting surface being disposed adjacent to and extending perpendicular from the clamping surface; and,
an outward face of the elongate monolithic body defining a camming surface, the camming surface being angled with respect to the clamping surface.

2. The plastic door rail wedge of claim 1, wherein one or more faces of each plastic door rail wedge comprises a textured surface.

3. The plastic door rail wedge of claim 1, wherein one or more faces of each plastic door rail wedge is treated to alter the frictional properties of the one or more faces.

4. A door rail for a door panel, the door rail comprising:
a frame comprising an opening;
a bracket disposed within the opening of the frame, the bracket comprising an interior region;
a first monolithic plastic door rail wedge disposed at least partially within the interior region of the bracket; and
a second monolithic plastic door rail wedge disposed at least partially within the interior region of the bracket and opposite the first monolithic plastic door rail wedge, the bracket configured to cam the first and second monolithic plastic door rail wedges toward each other to cause the monolithic plastic door rail wedges to clamp directly against the door panel.

5. The door rail of claim 4, wherein each monolithic plastic door rail wedge includes a cross section and wherein the cross section of the first monolithic plastic door rail wedge is a mirror image of the cross section of the second monolithic plastic door rail wedge.

6. The door rail of claim 4, wherein a force exerted on the bracket in a first direction causes the bracket to transmit at least a first portion of the force to the first monolithic plastic door rail wedge in a second direction and causes the bracket to transmit at least a second portion of the force to the second monolithic plastic door rail wedge in a third direction, wherein the second and third directions are perpendicular to the first direction, and wherein the second and third directions are parallel to each other, and wherein the first and second portions of the force extend in opposite directions.

7. The door rail of claim 6, wherein a fastener is configured move to cause the force exerted on the bracket.

8. The door rail of claim 4, wherein the door panel is a glass pane and wherein the first and second monolithic plastic door rail wedges are configured to secure the glass pane when the glass pane is disposed at least partially in the opening of the frame and at least partially between the first and second monolithic plastic door rail wedges.

9. The door rail of claim 4, wherein one or more faces of each monolithic plastic door rail wedge comprises a textured surface.

10. The door rail of claim 4, wherein one or more faces of each monolithic plastic door rail wedge is treated to alter the frictional properties of the one or more faces.

11. The door rail of claim 4, wherein the bracket is a metal bracket.
